(19) United States
(12) Patent Application Publication
(10) Pub. No.: US 2026/0268567 A1
(43) Pub. Date: Sep. 10, 2026

(54) SUMMARY INFORMATION GENERATION DEVICE, SUMMARY INFORMATION GENERATION METHOD, AND RECORDING MEDIUM

(71) Applicant: NEC Corporation, Tokyo (JP)

(72) Inventors: Keisuke KANEYASU, Tokyo (JP); Masahiko TANGE, Tokyo (JP)

(73) Assignee: NEC Corporation, Tokyo (JP)

(21) Appl. No.: 19/163,447

(22) PCT Filed: Mar. 17, 2023
(86) PCT No.: PCT/JP2023/010569

§ 371 Date: Sep. 9, 2025

(51) Int. Cl. G06T 13/40; G06F 40/166; G06F 40/289; G06T 13/80

(52) U.S. Cl. CPC G06T 13/40; G06F 40/166; G06F 40/289; G06T 13/80; G06T 2200/24

(57) ABSTRACT

In a summary information generation device, a state information acquisition means acquires state information regarding a plurality of avatars and a plurality of virtual objects. A motion information acquisition means acquires motion information regarding the plurality of avatars and the plurality of virtual objects by user operations. A conversation information acquisition means acquires conversation information regarding the plurality of avatars. A behavior recognition means recognizes behaviors of the plurality of avatars based on the state information and the motion information. An utterance content recognition means recognizes an utterance content of each of the plurality of avatars based on the conversation information. A summary information generation means generates summary information based on the state information, the motion information, the behaviors of the plurality of avatars, and the utterance content of each of the plurality of avatars.

### TECHNICAL FIELD

The present disclosure relates to generation of summary information in cyberspace.

### BACKGROUND ART

In recent years, cyberspace is becoming more and more prevalent, and a plurality of users can interact with each other on a network as in a real world. In order to smoothly perform communication, a user may desire to grasp a content of a conversation or an event that has occurred in the cyberspace. Patent Document 1 proposes a method of generating summary information from an operational log of a terminal.

### PRECEDING TECHNICAL REFERENCE

### Patent Document

Patent Document 1: WO 2021/084666 A 1

### SUMMARY

### Problem to be Solved

However, even with Patent Document 1, it is not always possible to easily grasp the content of the conversation or the event that has occurred in the cyberspace.

It is an example object of the present disclosure to provide a summary information generation device capable of generating summary information regarding an event that has occurred in cyberspace.

### Means for Solving the Problem

According to an example aspect of the present invention, there is provided a summary information generation device, including:
state information acquisition means for acquiring state information regarding a plurality of avatars and a plurality of virtual objects;
motion information acquisition means for acquiring motion information regarding the plurality of avatars and the plurality of virtual objects by user operations;
conversation information acquisition means for acquiring conversation information regarding the plurality of avatars;
behavior recognition means for recognizing behaviors of the plurality of avatars based on the state information and the motion information;
utterance content recognition means for recognizing an utterance content of each of the plurality of avatars based on the conversation information; and
summary information generation means for generating summary information based on the state information, the motion information, the behaviors of the plurality of avatars, and the utterance content of each of the plurality of avatars.

According to another example aspect of the present invention, there is provided a summary information generation method including:
acquiring state information regarding a plurality of avatars and a plurality of virtual objects;
acquiring motion information regarding the plurality of avatars and the plurality of virtual objects by user operations;
acquiring conversation information regarding the plurality of avatars;
recognizing behaviors of the plurality of avatars based on the state information and the motion information;
recognizing an utterance content of each of the plurality of avatars based on the conversation information; and
generating summary information based on the state information, the motion information, the behaviors of the plurality of avatars, and the utterance content of each of the plurality of avatars.

According to a further example aspect of the present invention, there is provided a recording medium recording a program for causing a computer to execute processing including:
acquiring state information regarding a plurality of avatars and a plurality of virtual objects;
acquiring motion information regarding the plurality of avatars and the plurality of virtual objects by user operations;
acquiring conversation information regarding the plurality of avatars;
recognizing behaviors of the plurality of avatars based on the state information and the motion information;
recognizing an utterance content of each of the plurality of avatars based on the conversation information; and
generating summary information based on the state information, the motion information, the behaviors of the plurality of avatars, and the utterance content of each of the plurality of avatars.

### Effect

According to the present disclosure, it is possible to generate summary information regarding an event that has occurred in cyberspace.

### BRIEF DESCRIPTION OF THE DRAWINGS

FIG. 1 illustrates an overall configuration of a cyberspace management system according to a first example embodiment.

FIG. 2 is a block diagram illustrating a configuration of a server.

FIG. 3 is a block diagram illustrating a functional configuration of the server.

FIG. 4 illustrates a display example of summary information.

FIG. 5 illustrates another display example of the summary information.

FIG. 6 illustrates another display example of the summary information.

FIG. 7 is a flowchart of summary information generation processing.

FIG. 8 is a block diagram illustrating a functional configuration of a summary information generation device of a second example embodiment.

FIG. 9 is a flowchart of processing by the summary information generation device of the second example embodiment.

### EXAMPLE EMBODIMENTS

Hereinafter, preferred example embodiments of the present disclosure will be described with reference to the drawings.

### First Example Embodiment

### System Configuration

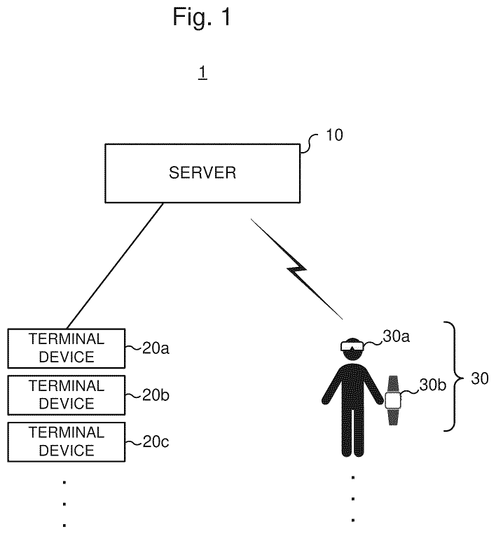

FIG. 1 illustrates an overall configuration of a cyberspace management system to which a summary information generation device according to the present disclosure is applied. A cyberspace management system 1 includes a server 10, terminal devices 20 used by users, and wearable devices 30 used by the users. The server 10 is an example of the summary information generation device.

It is assumed that there is the plurality of terminal devices 20, and subscripts are added to the terminal devices 20 in a case where the individual terminal devices are distinguished, and the plurality of terminal devices 20 is simply referred to as the “terminal devices 20” in a case where not being distinguished. Similarly, it is assumed that there is the plurality of wearable devices 30, and subscripts are added to the wearable devices 30 in a case where the individual wearable devices are distinguished, and the plurality of wearable devices 30 is simply referred to as the “wearable devices 30” in a case where not being distinguished. The server 10 and the terminal devices 20 can communicate with each other in a wired or wireless manner, and the server 10 and the wearable devices 30 can communicate with each other in a wired or wireless manner.

In the cyberspace management system 1, by the server 10 transmitting data of cyberspace to the terminal devices 20 in response to requests of the terminal devices 20, a place for communication among users is provided. In the present example embodiment, a virtual office as a virtual office space will be described as an example of the cyberspace provided by the cyberspace management system 1, but the cyberspace provided by the cyberspace management system 1 is not limited to this, and may be any cyberspace as long as it provides the place for the communication among the users.

Specifically, the server 10 draws virtual objects such as a desk, a chair, and a meeting room according to setting information prepared in advance, and generates data of the virtual office. In a case where a user accesses the server 10 using the terminal device 20 and logs in to the virtual office, the server 10 generates an avatar based on login information regarding the user and arranges the avatar in the virtual office. The server 10 then transmits the data of the virtual office to the terminal device 20.

The terminal device 20 is a terminal device such as a personal computer (PC) or a tablet. The user of the terminal device 20 acquires the data of the virtual office and displays the data on a display or the like, in such a way that the user can experience that the user is in the virtual office. The user can move his/her own avatar or communicate with an avatar of another user by operating his/her own avatar by using the terminal device 20.

The wearable device 30 is a terminal including a function of acquiring position information, biological information, and the like regarding the user, and is, for example, a terminal device such as a smartphone, a smart watch, or a smart glass. Examples of the biological information regarding the user include a body temperature, a heart rate, a pulse, a line of sight, and a voice. The wearable device 30 transmits the position information, the biological information, and the like to the server 10 at predetermined timings. The position information, the biological information, and the like of the user in a real space are hereinafter also referred to as “multimodal information”.

In the present example embodiment, the server 10 further generates summary information and transmits the summary information to the terminal device 20. The summary information is information summarizing an event that occurred in the past in the virtual office, and includes a text, a video, and the like. The server 10 generates the summary information in response to a request from the terminal device 20. At this time, when the user specifies a generation condition of the summary information, the server 10 generates the summary information according to the condition and transmits the summary information to the terminal device 20 of the user. With this arrangement, the user can grasp a content of a conversation or an event occurred in the virtual office.

### Hardware Configuration

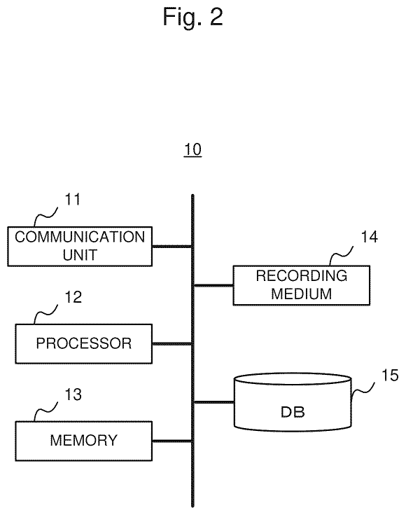

FIG. 2 is a block diagram illustrating a hardware configuration of the server 10. The server 10 mainly includes a communication unit 11, a processor 12, a memory 13, a recording medium 14, and a database (DB) 15.

The communication unit 11 transmits and receives data to and from an external device. Specifically, the communication unit 11 transmits and receives information to and from the terminal device 20 and the wearable device 30.

The processor 12 is a computer such as a central processing unit (CPU), and controls the entire server 10 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), and the like. The memory 13 stores various programs executed by the processor 12. The memory 13 is also used as a work memory during execution of various types of processing by the processor 12.

The recording medium 14 is a non-volatile non-transitory recording medium such as a disk-shaped recording medium or a semiconductor memory, and is attachable to and detachable from the server 10. The recording medium 14 records various programs executed by the processor 12.

The database (DB) 15 stores information regarding a user, information regarding cyberspace, various types of information used to generate summary information, and the like. The information regarding the cyberspace includes, for example, information such as coordinates and a display form of a virtual object. The various types of information used to generate the summary information include a history of state information, a history of motion information, a history of conversation information, a behavior history of an avatar, a conversation content history, and the like, which will be described later. The DB 15 may include an external storage device such as a hard disk connected to or built in the server 10, or may include a storage medium such as a freely attachable and detachable flash memory. Instead of providing the DB 15 in the server 10, the DB 15 may be provided in an external server or the like, and the information regarding the user, the information regarding the cyberspace, the various types of information used to generate the summary information, and the like may be stored in the server by communication.

The server 10 may include an input unit such as a keyboard and a mouse for an administrator or the like to perform instruction and input, and a display unit such as a liquid crystal display.

### Functional Configuration

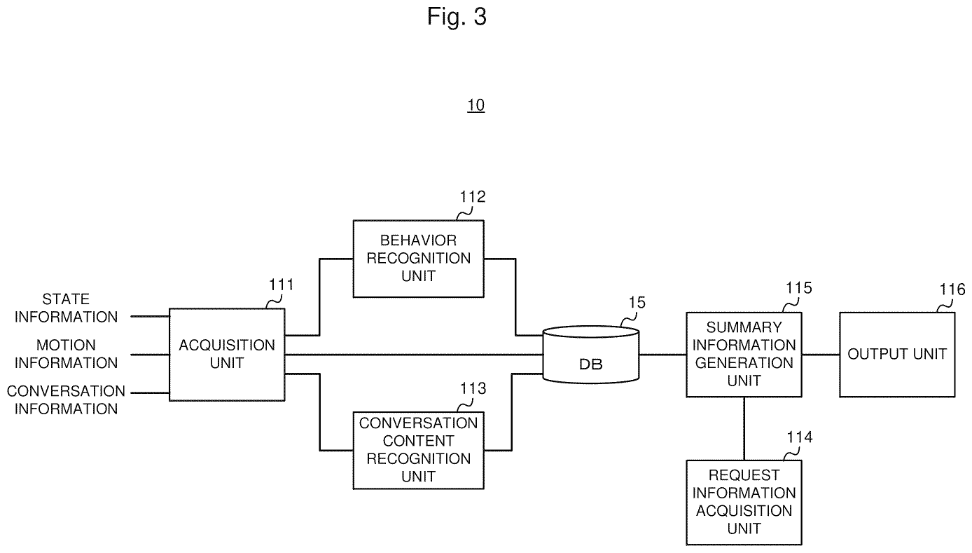

FIG. 3 is a block diagram illustrating a functional configuration of the server 10 according to the first example embodiment. The server 10 functionally includes an acquisition unit 111, a behavior recognition unit 112, a conversation content recognition unit 113, a request information acquisition unit 114, a summary information generation unit 115, and an output unit 116, in addition to the DB 15 described above.

The acquisition unit 111 collects state information regarding an avatar or a virtual object, motion information regarding an avatar or a virtual object, and conversation information regarding avatars at predetermined timings.

The “state information regarding an avatar or a virtual object” includes a log in which a state such as a position, a shape, a color, a size, hardness, or a weight of the avatar or the virtual object is recorded, a log in which a change in the state is recorded, and the like. Hereinafter, the state information regarding the avatar or the virtual object is also simply referred to as the “state information”.

The “motion information regarding an avatar or a virtual object” includes a log in which an operation performed on the avatar or the virtual object by a user is recorded, and the like. Hereinafter, the motion information regarding the avatar or the virtual object is also simply referred to as the “motion information”.

The “conversation information regarding avatars” is information regarding a conversation between avatars, and includes voice data, text data, image data, and the like. The acquisition unit 111 can acquire the conversation information regarding the avatars from a call, a chat, a whiteboard, a shared screen, or the like on a virtual office. Hereinafter, the conversation information regarding the avatars is also simply referred to as the “conversation information”.

The acquisition unit 111 outputs the state information, the motion information, and the conversation information to the DB 15. The acquisition unit 111 outputs the state information and the motion information to the behavior recognition unit 112. The acquisition unit 111 outputs the conversation information to the conversation content recognition unit 113.

The behavior recognition unit 112 receives the input of the state information and the motion information from the acquisition unit 111. The behavior recognition unit 112 estimates a behavior of an avatar based on the state information and the motion information.

Specifically, the behavior recognition unit 112 estimates the behavior of the avatar using a behavior recognition model or the like prepared in advance. The behavior recognition model is a machine learning model trained in advance using learning data in which a combination of the state information and the motion information is associated with a behavior for the combination. For example, the behavior recognition model can estimate the behavior of the avatar such as “holding a virtual object” or “throwing a virtual object” from a combination of a change in a position of the virtual object (state information) and operation information regarding the avatar (motion information).

The behavior recognition model used by the behavior recognition unit 112 is not limited to the above. The behavior recognition model may be a machine learning model trained in advance using learning data generated by labeling, for a large number of videos in cyberspace, behaviors of avatars included in the videos. In the case of using this model, first, the behavior recognition unit 112 reproduces the virtual office in a predetermined time zone with a video based on the state information and the motion information. The behavior recognition unit 112 then detects the avatar from the reproduction video using the behavior recognition model, and estimates the behavior of the avatar.

The behavior recognition unit 112 outputs the estimated behavior of the avatar to the DB 15.

The conversation content recognition unit 113 receives the input of the conversation information from the acquisition unit 111. The conversation content recognition unit 113 estimates a conversation content based on the conversation information. Specifically, in a case where the conversation information includes voice data or image data, the conversation content recognition unit 113 converts a content of the voice data or the image data into text data. For example, the conversation content recognition unit 113 can convert the voice data into the text data by performing voice recognition processing on the voice data included in the conversation information. The conversation content recognition unit 113 can convert the image data into the text data by performing character recognition processing on the image data included in the conversation information. The conversation content recognition unit 113 outputs the estimated conversation content to the DB 15.

The DB 15 receives the input of the state information, the motion information, and the conversation information from the acquisition unit 111, receives the input of the behavior of the avatar from the behavior recognition unit 112, and receives the input of the conversation content from the conversation content recognition unit 113. The DB 15 accumulates various types of the input information.

The server 10 receives a generation request of summary information and request information from the terminal device 20 through the communication unit 11. The request information is a generation condition of the summary information specified by the user. The user can specify a person, a place, a time, a behavior, other keywords, and the like as the request information. For example, in a case where the user desires to know summary information regarding a predetermined person, the user specifies a name of the person or the like as the request information. In a case where the user desires to know summary information regarding a predetermined meeting, the user specifies a place or a time zone in which the meeting was held as the request information. The request information acquisition unit 114 acquires the generation request of the summary information and the request information, and outputs the generation request of the summary information and the request information to the summary information generation unit 115.

The summary information generation unit 115 receives the input of the generation request of the summary information and the request information from the request information acquisition unit 114. The summary information generation unit 115 generates the summary information based on the generation request of the summary information and the request information.

Specifically, the summary information generation unit 115 can generate the summary information as a text. The summary information generation unit 115 extracts, from the DB 15, a behavior of an avatar including the request information or a word highly related to the request information and behaviors of the avatar before and after the behavior, or a conversation content including the request information or a word highly related to the request information and conversation contents before and after the conversation content. The word highly related to the request information is acquired from a synonym dictionary or the like created in advance. The summary information generation unit 115 then generates the summary information using a machine learning model prepared in advance. The machine learning model is a model trained in advance in such a way as to generate summary information using a series of behaviors or a series of conversation contents of an avatar as an input, and is hereinafter also referred to as a summary information generation model. The summary information generation model can be generated by, for example, performing training using a large number of pieces of learning data in which summary information is added to a series of behaviors or a series of conversation contents as a correct answer.

The summary information generation unit 115 can generate the summary information as a video. The summary information generation unit 115 searches the DB 15 for a behavior of an avatar including the request information or a word highly related to the request information, or a conversation content including the request information or a word highly related to the request information. Based on a date and time of the behavior of the avatar or a date and time when a conversation has occurred, the summary information generation unit 115 then extracts, from the DB 15, state information, motion information, and conversation information in the date and time and a time before and after the date and time. The summary information generation unit 115 generates a video reproducing the virtual office (hereinafter, also referred to as a “reproduction video”) based on the extracted state information, motion information, and conversation information. In a case where a plurality of the reproduction videos is generated by searching for a plurality of the behaviors or conversation contents of the avatar, the summary information generation unit 115 generates one highlight video by arranging the plurality of reproduction videos in time series.

For example, the summary information generation unit 115 can select whether to generate the summary information as the text or the video in response to a request of the user.

The user can specify a data amount of the summary information such as the number of characters and a time of the video. In a case where the generated summary information exceeds the specified data amount, the summary information generation unit 115 may regenerate the summary information in such a way that the generated summary information falls within the specified data amount based on a word having a high importance level determined in advance.

In a case where the user does not specify the request information and makes only the generation request of the summary information, the summary information generation unit 115 may generate the summary information based on a behavior or a conversation content of the avatar including the word having the high importance level determined in advance.

The summary information generation unit 115 outputs the generated summary information to the output unit 116.

The output unit 116 receives the input of the summary information from the summary information generation unit 115. The output unit 116 generates display data based on the summary information, and transmits the display data to the terminal device 20.

In the above configuration, the acquisition unit 111 is an example of state information acquisition means, motion information acquisition means, and conversation information acquisition means, the behavior recognition unit 112 is an example of behavior recognition means, the conversation content recognition unit 113 is an example of utterance content recognition means, the request information acquisition unit 114 is an example of request information acquisition means, and the summary information generation unit 115 and the output unit 116 are examples of summary information generation means.

### Display Example

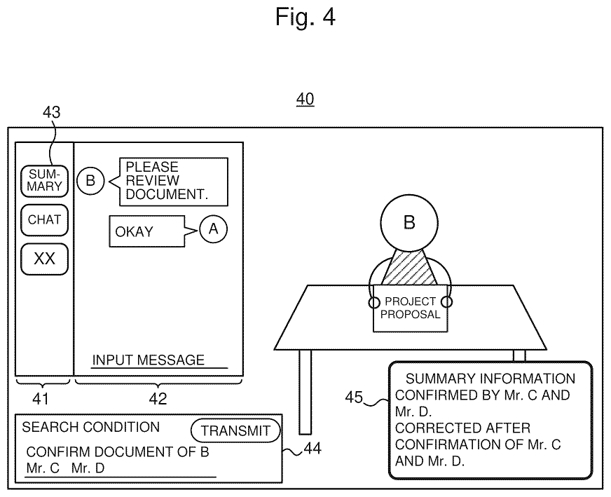

FIG. 4 illustrates a display example of the summary information transmitted by the server 10. In this example, it is assumed that a certain user logs in a virtual office and operates an avatar A. It is also assumed that the avatar A faces an avatar B, and the avatar B requests the avatar A to review a document. A virtual office 40 includes a menu area 41, a chat area 42, a summary icon 43, a request information input area 44, and a summary information area 45.

In the menu area 41, icons for executing functions of the virtual office are displayed. In the chat area 42, information can be exchanged between users by a chat function. The chat area 42 is displayed by, for example, a user pressing an icon in the menu area. The summary icon 43 is an icon for displaying summary information. The request information input area 44 is an area for inputting request information. In a case where the user presses the summary icon 43, the request information input area 44 is displayed. In a case where the user inputs the request information in the request information input area 44 and presses a transmission button, a generation request of the summary information and the request information are transmitted to the server 10. In FIG. 4, the user of the avatar A inputs request information such as “confirm the document of B” in the request information input area 44 in order to confirm whether the avatar B has shown the document to others in advance. The summary information generated by the server 10 is displayed in the summary information area 45. The user of the avatar A can grasp that the document of the avatar B has been confirmed by Mr. C and Mr. D by viewing the summary information as illustrated in FIG. 4.

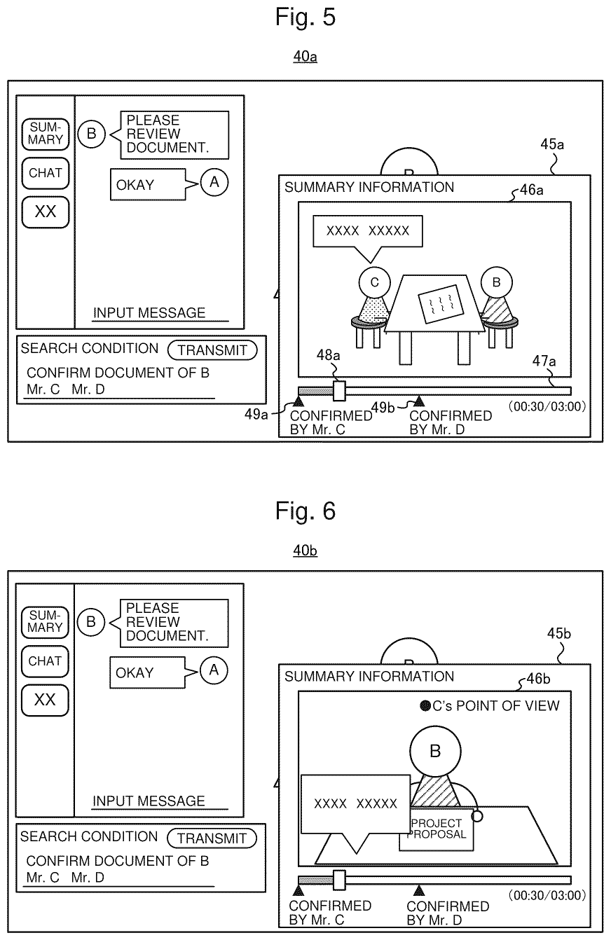

FIGS. 5 and 6 illustrate other display examples of the summary information transmitted by the server 10. These examples are different from the display example of FIG. 4 in that the summary information is displayed as a video.

In FIG. 5, a summary information area 45a includes a video area 46a, a seek bar 47a, a slider bar 48a, and chapters 49a and 49b. The summary information generated by the server 10 is displayed in the video area 46a. In FIG. 5, as the summary information, a video in which the avatar C comments on the document with respect to the avatar B is displayed from a third party's point of view. With such video display, the user of the avatar A can grasp that the avatar C is confirming the document of the avatar B.

The seek bar 47a indicates a progress situation of the video. The user can grasp which part of the entire video is being reproduced by a position of the slider bar 48a on the seek bar 47a. The user can change a reproduction position of the video by moving the position of the slider bar 48a to the left and right. The chapters 49a and 49b indicate sections of the video. A reason for presentation (hereinafter, also referred to as a “title”) is added to each chapter. In FIG. 5, the avatar C and the avatar D are confirming the document of the avatar B, and a title such as “confirmed by Mr. C” is added to a start point of the confirmation of the document by the avatar C, and a title such as “confirmed by Mr. D” is added to a start point of the confirmation of the document by the avatar D. The title can be generated by the server 10 using, for example, a machine learning model trained in advance in such a way as to generate the title using the summary information as an input. With such display, the user of the avatar A can easily grasp a start point of a scene that the user desires to see.

In FIG. 5, the video from the third party's point of view is displayed as the summary information, but a video from another point of view may be displayed. For example, in FIG. 6, a video from an avatar C's point of view is displayed in a video area 46b. The server 10 can generate videos from various points of view in response to a request of the user or the like.

By displaying the summary information as the video as illustrated in FIGS. 5 and 6, the user can grasp a situation at that time in more detail.

### Summary Information Generation Processing

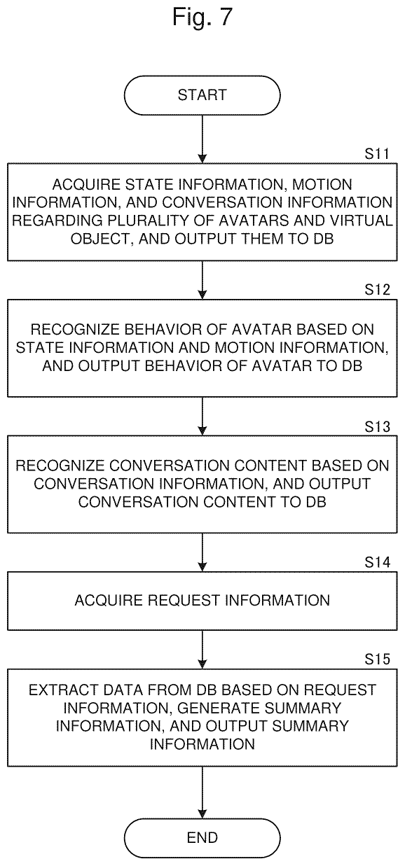

Next, summary information generation processing of generating the summary information as described above will be described. FIG. 7 is a flowchart of the summary information generation processing by the server 10. This processing is achieved by the processor 12 illustrated in FIG. 2 executing a program prepared in advance and operating as each element illustrated in FIG. 3.

The acquisition unit 111 collects state information regarding an avatar or a virtual object, motion information regarding an avatar or a virtual object, and conversation information regarding avatars at predetermined timings. The acquisition unit 111 outputs the state information, the motion information, and the conversation information to the DB 15. The acquisition unit 111 outputs the state information and the motion information to the behavior recognition unit 112, and outputs the conversation information to the conversation content recognition unit 113 (step S11).

Next, the behavior recognition unit 112 estimates a behavior of an avatar based on the state information and the motion information. The behavior recognition unit 112 outputs the estimated behavior of the avatar to the DB 15 (step S12). Specifically, the behavior recognition unit 112 estimates the behavior of the avatar using the behavior recognition model.

Next, the conversation content recognition unit 113 estimates a conversation content based on the conversation information. The conversation content recognition unit 113 outputs the estimated conversation content to the DB 15 (step S13). Specifically, in a case where the conversation information includes voice data or image data, the conversation content recognition unit 113 converts a content of the voice data or the image data into text data by performing the voice recognition processing or the character recognition processing.

The server 10 receives a generation request of summary information and the request information from the terminal device 20 through the communication unit 11. The request information acquisition unit 114 acquires the generation request of the summary information and the request information, and outputs the generation request of the summary information and the request information to the summary information generation unit 115 (step S14).

The summary information generation unit 115 extracts data including the request information or a word highly related to the request information and data before and after the data from the DB 15, and generates the summary information. The summary information generation unit 115 outputs the generated summary information to the output unit 116 (step S15), and the processing ends.

### Modification

Next, a modification of the first example embodiment will be described.

### Modification

The server 10 may generate the summary information using the multimodal information in addition to the state information, the motion information, the conversation information, the behavior of the avatar, and the conversation content. For example, the server 10 estimates an emotion of the user using the multimodal information, and accumulates the estimated emotion in the DB 15. For example, the server 10 can estimate the emotion by using a machine learning model using the multimodal information as an input and which emotion the multimodal information corresponds to among a plurality of emotions determined in advance as an output. With this arrangement, the user can include emotions such as “smiling” and “angry” in the request information, and the server 10 can generate the summary information based on the request information.

### Second Example Embodiment

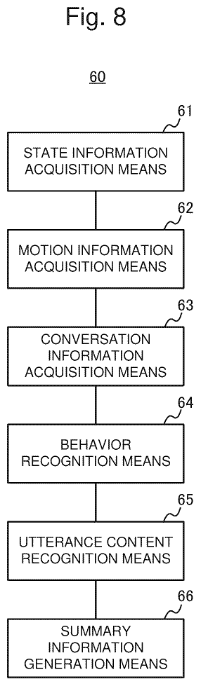

FIG. 8 is a block diagram illustrating a functional configuration of a request information generation device of a second example embodiment. A request information generation device 60 includes state information acquisition means 61, motion information acquisition means 62, conversation information acquisition means 63, behavior recognition means 64, utterance content recognition means 65, and summary information generation means 66.

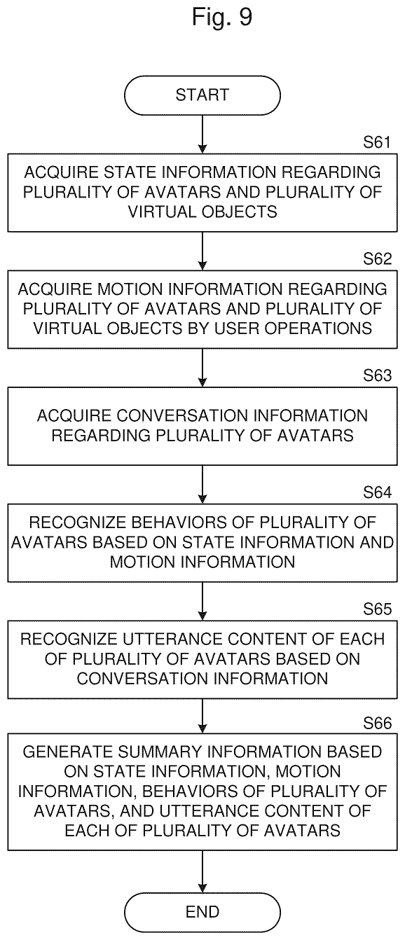

FIG. 9 is a flowchart of processing by the request information generation device of the second example embodiment. The state information acquisition means 61 acquires state information regarding a plurality of avatars and a plurality of virtual objects (step S61). The motion information acquisition means 62 acquires motion information regarding the plurality of avatars and the plurality of virtual objects by user operations (step S62). The conversation information acquisition means 63 acquires conversation information regarding the plurality of avatars (step S63). The behavior recognition means 64 recognizes behaviors of the plurality of avatars based on the state information and the motion information (step S64). The utterance content recognition means 65 recognizes an utterance content of each of the plurality of avatars based on the conversation information (step S65). The summary information generation means 66 generates summary information based on the state information, the motion information, the behaviors of the plurality of avatars, and the utterance content of each of the plurality of avatars (step S66).

According to the request information generation device 60 of the second example embodiment, it is possible to generate summary information regarding an event that has occurred in cyberspace.

Some or all of the above example embodiments may also be described as the following Supplementary Notes, but are not limited to the following Supplementary Notes.

### Supplementary Note 1

A summary information generation device comprising:
state information acquisition means for acquiring state information regarding a plurality of avatars and a plurality of virtual objects;
motion information acquisition means for acquiring motion information regarding the plurality of avatars and the plurality of virtual objects by user operations;
conversation information acquisition means for acquiring conversation information regarding the plurality of avatars;
behavior recognition means for recognizing behaviors of the plurality of avatars based on the state information and the motion information;
utterance content recognition means for recognizing an utterance content of each of the plurality of avatars based on the conversation information; and
summary information generation means for generating summary information based on the state information, the motion information, the behaviors of the plurality of avatars, and the utterance content of each of the plurality of avatars.

### Supplementary Note 2

The summary information generation device according to supplementary note 1, further comprising
request information acquisition means for receiving an input of a generation condition of the summary information by a user,
wherein the summary information generation means generates the summary information based on the state information, the motion information, the behaviors of the plurality of avatars, the utterance content of each of the plurality of avatars, and the generation condition.

### Supplementary Note 3

The summary information generation device according to supplementary note 2, wherein the summary information generation means generates the summary information as a text.

### Supplementary Note 4

The summary information generation device according to supplementary note 2, wherein the summary information generation means generates the summary information as a highlight video.

### Supplementary Note 5

The summary information generation device according to supplementary note 4, wherein the summary information generation means provides a start point of each event on a seek bar of the highlight video, and gives a reason for presentation to the start point of each event.

### Supplementary Note 6

A summary information generation method comprising:
acquiring state information regarding a plurality of avatars and a plurality of virtual objects;
acquiring motion information regarding the plurality of avatars and the plurality of virtual objects by user operations;
acquiring conversation information regarding the plurality of avatars;
recognizing behaviors of the plurality of avatars based on the state information and the motion information;
recognizing an utterance content of each of the plurality of avatars based on the conversation information; and
generating summary information based on the state information, the motion information, the behaviors of the plurality of avatars, and the utterance content of each of the plurality of avatars.

### Supplementary Note 7

A recording medium recording a program for causing a computer to execute processing comprising:
acquiring state information regarding a plurality of avatars and a plurality of virtual objects;
acquiring motion information regarding the plurality of avatars and the plurality of virtual objects by user operations;
acquiring conversation information regarding the plurality of avatars; recognizing behaviors of the plurality of avatars based on the state information and the motion information;
recognizing an utterance content of each of the plurality of avatars based on the conversation information; and
generating summary information based on the state information, the motion information, the behaviors of the plurality of avatars, and the utterance content of each of the plurality of avatars.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 cyberspace management system
10 server
15 database (DB)
20 terminal device
30 wearable device
111 acquisition unit
112 behavior recognition unit
113 conversation content recognition unit
114 request information acquisition unit
115 summary information generation unit
116 output unit

What is claimed is:

1. A summary information generation device comprising:
at least one memory configured to store instructions; and
at least one processor configured to execute the instructions to:
acquire state information regarding a plurality of avatars and a plurality of virtual objects;
acquire motion information regarding the plurality of avatars and the plurality of virtual objects by user operations;
acquire conversation information regarding the plurality of avatars;
recognize behaviors of the plurality of avatars based on the state information and the motion information;
recognize an utterance content of each of the plurality of avatars based on the conversation information; and
generate summary information based on the state information, the motion information, the behaviors of the plurality of avatars, and the utterance content of each of the plurality of avatars.

2. The summary information generation device according to claim 1,
wherein the one or more processors are further configured to receive an input of a generation condition of the summary information by a user,
wherein the one or more processors generate the summary information based on the state information, the motion information, the behaviors of the plurality of avatars, the utterance content of each of the plurality of avatars, and the generation condition.

3. The summary information generation device according to claim 2, wherein the one or more processors generate the summary information as a text.

4. The summary information generation device according to claim 2, wherein the one or more processors generate the summary information as a highlight video.

5. The summary information generation device according to claim 4, wherein one or more processors provide a start point of each event on a seek bar of the highlight video, and gives a reason for presentation to the start point of each event.

6. A summary information generation method comprising:
acquiring state information regarding a plurality of avatars and a plurality of virtual objects;
acquiring motion information regarding the plurality of avatars and the plurality of virtual objects by user operations;
acquiring conversation information regarding the plurality of avatars;
recognizing behaviors of the plurality of avatars based on the state information and the motion information;
recognizing an utterance content of each of the plurality of avatars based on the conversation information; and
generating summary information based on the state information, the motion information, the behaviors of the plurality of avatars, and the utterance content of each of the plurality of avatars.

7. A non-transitory computer-readable recording medium recording a program for causing a computer to execute processing comprising:
acquiring state information regarding a plurality of avatars and a plurality of virtual objects;
acquiring motion information regarding the plurality of avatars and the plurality of virtual objects by user operations;
acquiring conversation information regarding the plurality of avatars;
recognizing behaviors of the plurality of avatars based on the state information and the motion information;
recognizing an utterance content of each of the plurality of avatars based on the conversation information; and
generating summary information based on the state information, the motion information, the behaviors of the plurality of avatars, and the utterance content of each of the plurality of avatars.
